(19) United States
(12) Patent Application Publication
(10) Pub. No.: US 2007/0072055 A1
(43) Pub. Date: Mar. 29, 2007

(54) Membrane-electrode assemblies for direct methanol fuel cells

(76) Inventors: S. R. Narayanan, Altadena, CA (US); Thomas Valdez, Covina, CA (US)

Correspondence Address: FISH & RICHARDSON, PC, P.O. BOX 1022, MINNEAPOLIS, MN, 55440-1022, US

(21) Appl. No.: 11/601,356

(22) Filed: Nov. 16, 2006

Related U.S. Application Data
(63) Continuation of application No. 09/882,607, filed on Jun. 15, 2001, now abandoned.
Application No. 09/882,607 is a division of application No. 09/489,514, filed on Jan. 21, 2000.
(60) Provisional application No. 60/116,742, filed on Jan. 22, 1999.

(51) Int. Cl. H01M 4/86; H01M 4/92; B01J 31/00

(52) U.S. Cl. 429/42; 502/159

(57) ABSTRACT

A catalyst ink for use in a fuel cell includes water, particles of a fluorocarbon polymer with a particle size of about 1 to about 12 microns, and a catalytic material. The ink may be applied to a substrate to form an electrode, or bonded with other electrode layers to form a membrane electrode assembly (MEA).

### CROSS-REFERENCE TO RELATED APPLICATIONS

This application is a continuation of U.S. application Ser. No. 09/882,607, filed Jun. 15, 2001, which is a divisional of U.S. application Ser. No. 09/489,514, filed Jan. 21, 2000, which claims the benefit of provisional application U.S. Ser. No. 60/116,742, filed Jan. 22, 1999.

### STATEMENT REGARDING FEDERALLY SPONSORED RESEARCH OR DEVELOPMENT

This work was sponsored by the National Aeronautical and Space Administration (NASA).

### FIELD OF THE INVENTION

This invention relates to membrane electrode assemblies for direct feed methanol fuel cells. In particular, this invention relates to catalytic ink formulations for membrane electrode assemblies.

### BACKGROUND

During operation of the direct methanol fuel cell, water is produced at the cathode in significant amounts. The water so produced blocks the access of the catalyst sites to the reactant air and results in a lower voltage. Therefore, water must be removed from the cathode structure to allow the cell to perform efficiently.

A condensation process may be used to recover the water from the cathode structure. In this process water is recovered by condensing heat exchangers. However, the heat exchangers add significantly to the overall size and mass of the system, and even decrease the efficiency of the fuel cell system.

Water may also be more easily recovered by operating the fuel cell system at a high flow rate. The large excess of flowing air evaporates the water from the cathode structure. The flow rate of air is usually quantified as number of times the stoichiometric rate requirement. This may also be viewed as a utilization level for the oxygen that passes through the stack. Current designs of membrane electrode assemblies for direct methanol fuel cells require fairly high flow rates of air (4-6 times the stoichiometric flow rate or under 10-25% utilization) in order to perform satisfactorily. Also, the performance of state-of-art cells drops below a useful value at stoichiometric flow rates of 3 or under. Thus it is important to realize a design that will be able to operate at an air flow rate close to the stoichiometric flow rate of 1.5-2.0 and achieve a performance level of 0.4V at 100 mA/cm².

In hydrogen-air fuel cells, water may be removed from the zone of reaction by introducing hydrophobic components in the catalyst layer and the backing structure. The commonly preferred hydrophobic components used for this purpose are commercial polymers such as tetrafluoroethylene fluorocarbon polymers available from E.I. duPont de Nemours, Inc. under the trade designation TEFLON, or fluorinated ethylene polymer (FEP).

Therefore, it is desirable to add hydrophobic components such as TEFLON to the catalyst layer in the cathodes for direct methanol fuel cells. Known techniques for introducing hydrophobic components into the catalyst layer use an emulsion of TEFLON in an aqueous solution including water, surfactants and ammonium hydroxide. These emulsions require subsequent heat treatment of the electrodes at temperatures as high as 350° C. in order to render the TEFLON hydrophobic, and remove the surfactants and ammonium hydroxide additives present in the emulsion. These processes for introducing TEFLON into the catalyst layer can be implemented only when pre-formed electrodes are used.

### SUMMARY

In one aspect, the invention is a catalyst ink for a fuel cell that includes particles of a fluorocarbon polymer with a particle size of about 1 to about 12 microns, and a catalytic material.

In another aspect, the invention is a process for making a catalyst ink for a fuel cell, that includes mixing, at room temperature, components including particles of a fluorocarbon polymer with a particle size of about 1 to about 4 microns, and a catalytic material.

In another embodiment of the invention, the catalyst ink is applied at room temperature to at least one side of a substrate to make a membrane electrode assembly for a fuel cell.

In yet another embodiment of the invention, the catalyst ink is applied at room temperature to at least one side of a membrane, and the membrane is bonded to at least one electrode to make a membrane electrode assembly for a fuel cell.

Another embodiment of the invention is a fuel cell that uses the membrane electrode assembly with the catalyst ink.

In high performance methanol fuel cells, the catalyst is applied directly on a polymer electrolyte membrane. These structures cannot be heat treated beyond about 200° C. Thus, conventional TEFLON emulsion methods cannot be used to introduce hydrophobic components into the catalyst layer. In addition, TEFLON emulsions do not allow easy control of the particle size of the hydrophobic component. Therefore, the present invention is directed to a procedure for incorporating hydrophobic components at temperature compatible with membrane chemistry. The process of the invention also allows precise control over the characteristics of the hydrophobic component in the catalyst ink. The fuel cells using the membrane electrode assemblies made according to the invention operate at low air flow rates and remove water at the cathode effectively with minimal use of evaporative processes. Power sources that use these fuel cells may be made smaller and more efficient than conventional fuel cell power systems.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is schematic cross sectional view of a direct feed fuel cell.

FIG. 2 is a plot of cell voltage vs. current density that compares the performance of a conventional membrane electrode assembly to that of a membrane electrode assembly of the invention.

Like reference symbols in the various drawings indicate like elements.

### DETAILED DESCRIPTION

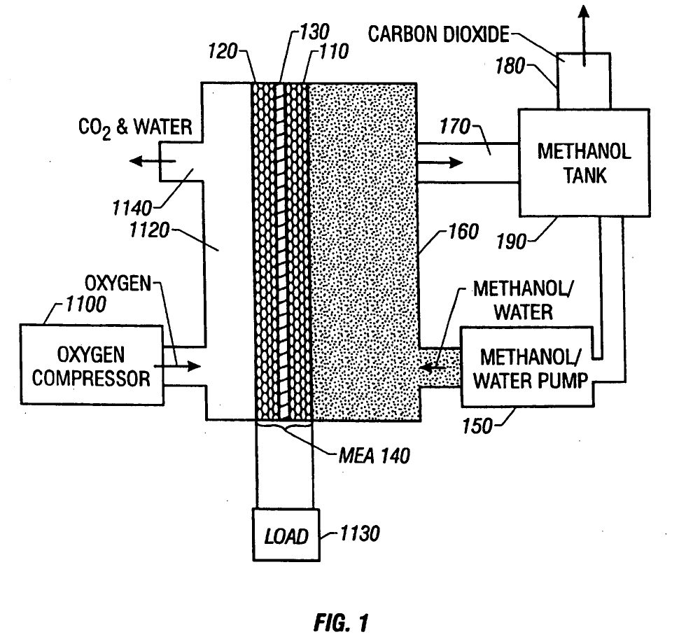

FIG. 1 illustrates a liquid feed organic fuel cell having anode 110, cathode 120 and solid polymer proton-conducting cation-exchange electrolyte membrane 130, preferable made of a perfluorinated proton-exchange membrane material available from E.I. duPONT de Nemours, Wilmington, Del. USA, under the trade designation NAFION. NAFION is a co-polymer of tetrafluoroethylene and perfluorovinylether sulfonic acid. Other membrane materials can also be used.

Anode 110, cathode 120 and solid polymer electrolyte membrane 130 are bonded to form a single multi-layer composite structure, referred to herein as membrane-electrode assembly “MEA” 140.

A fuel pump 150 is provided for pumping an organic fuel and water solution into anode chamber 160. The organic fuel and water mixture is withdrawn through outlet port 170 into a methanol tank 190 and re-circulated. Carbon dioxide formed in anode chamber 160 is vented through port 180 within the tank 190. An air compressor 1100 is provided to feed oxygen or air into a cathode chamber 1120. Carbon dioxide and water are removed through a port 1140 in the cathode chamber 1120.

Prior to use, anode chamber 160 is filled with the organic fuel and water mixture. Cathode chamber 1120 is filled with air or oxygen either at ambient pressure or in a pressurized state. During operation, the organic fuel in anode chamber 160 is circulated past anode 110. Oxygen or air is pumped into cathode chamber 1120 and circulated past cathode 120. When electrical load 1130 is connected between anode 110 and cathode 120, electro-oxidation of the organic fuel occurs at anode 110 and electro-reduction of oxygen occurs at cathode 120. The occurrence of different reactions at anode 110 and cathode 120 give rise to a voltage difference between those two electrodes.

Electrons generated by electro-oxidation at anode 110 are conducted through external load 1130 and are captured at cathode 120. Hydrogen ions or protons generated at anode 110 are transported directly across membrane electrolyte 130 to cathode 120. A flow of current is sustained by a flow of ions through the cell and electrons through external load 1130.

The cathode 120 is a gas diffusion electrode in which unsupported or supported platinum particles are bonded to one side of the membrane 130. In the process of the invention, a catalytic composition, referred to herein as a catalyst ink, is applied to at least one surface of the membrane 130 or to at least one surface of an electrode backing material.

The cathode catalyst ink is preferably water based and includes a catalytic material and a hydrophobic compound to create a three-phase boundary and to achieve efficient removal of water produced by electro-reduction of oxygen. The catalytic material may be in the form of fine metal powders (unsupported), or dispersed on high surface area carbon (supported), and is preferably unsupported platinum black, fuel cell grade, available from Johnson Matthey Inc., USA or supported platinum materials available from E-Tek Inc., USA.

The hydrophobic compound may vary widely depending on the intended application, but fluorocarbon polymers have been found suitable. Suitable fluorocarbon polymers include, for example, polytetrafluoroethylene, chlorotrifluoroethylene, fluorinated ethylene-propylene, polyvinylidene fluoride, and hexafluoropropylene. Preferred fluorocarbon polymers include polytetrafluoroethylene, and fluorinated ethylene-propylene, and polytetrafluoroethylene is particularly preferred.

The cathode catalyst ink of the invention preferably includes as a hydrophobic component TEFLON polytetrafluoroethylene microparticulate polymer particles available under the trade designations MP 1000, MP 1100, MP 1200 and MP 1300 from E.I. duPont de Nemours, Inc., Wilmington, Del. USA. These microparticles have an average particle size of about 4 microns to about 12 microns as measured by a MP Leeds Northrup Microtrac II particle size analyzer. The surface area of the particles is about 1.5 m²/g to about 10 m²/g as measured by electron microscopy.

The micro-particulate TEFLON material found to be most suitable for the catalytic ink of the invention is the MP-1100 grade, which has an average particle size in the range of about 1 to about 4 microns and a surface area of about 5 m²/g to about 10 m²/g. MP-1100 is a free flowing powder and does not include any surfactants.

The MP-1000, MP-1200 and MP-1300 have larger particle sizes and could be used in conjunction with or separately from MP-1100 to yield the desired results, although the preferred mode is to use MP-1100 alone. The use of microparticles of MP-1100, 1000, 1200 or 1300 with definite particle size allows the control of the aggregate structure of the hydrophobic element in the cathode ink composition.

The cathode ink preferably contains about 10 to about 50 weight percent TEFLON to provide hydrophobicity.

The cathode catalyst ink may also include an ionomer to improve ion conduction and provide improved fuel cell performance. The preferred ionomer materials include perflurosulfonic acid, e.g. NAFION, alone or in combination with TEFLON. A preferred form for the ionomer is a liquid copolymer of.perfluorovinylether sulfonic acid and tetraflouoroethylene.

The cathode catalyst ink is preferably applied directly on at least one side of a substrate such as the membrane 130 or on an electrode backing material to form a catalyst-coated electrode. Suitable backing materials include, for example, carbon fiber papers manufactured by Toray Industries, Tokyo, Japan. These carbon papers are preferably “TEFLONized” to be about 5 wt % in TEFLON.

The application process includes spraying or otherwise painting the catalyst ink onto the substrate, with both the ink and the substrate at or substantially near room temperature. No high temperature treatment step is required to activate the hydrophobic particles in the catalyst ink solution. After drying on the substrate, the loading of the catalyst particles onto the substrate is preferably in the range of about 0.5 mg/cm² to about 4.0 mg/cm².

The application of the catalyst ink on to the membrane is significantly improved if the membrane surface is roughened prior to the application of the catalyst ink. The membrane may be roughened by contacting the membrane surface with a commercial paper coated with fine abrasive. The abrasive should preferably have a grit size in the range of about 300 to about 400.

The abrasive material should be selected such that particles of the abrasive impregnated in the membrane are tolerated by the fuel cell. Abrasives that are preferred are silicon nitride, boron nitride, silicon carbide, silica and boron carbide. Abrasive using iron oxide or aluminum oxide should be avoided as these materials result contaminate the membrane with metal ions leading to increased resistance and this is undesirable.

Both sides of the membrane are roughened. The membrane is then held in a fixture and preferably allowed to dry before the catalyst ink is painted.

The anode 110 is formed from supported or unsupported platinum-ruthenium particles. A bimetallic powder, having separate platinum particles and separate ruthenium particles gives better results than platinum-ruthenium alloy. In a preferred embodiment, the platinum and ruthenium compounds are uniformly mixed and randomly spaced throughout the material, i.e., the material is homogeneous. This homogeneous bimetallic powder is used as the anode catalyst material. The preferred ratio of platinum to ruthenium can be between 60/40 and 40/60. The desired performance level is believed to occur at 60% platinum, 40% ruthenium. Performance degrades slightly as the catalyst becomes 100% platinum. Performance degrades more sharply as the catalyst becomes 100% ruthenium. For platinum-ruthenium, the loading of the alloy particles in the electrocatalyst layer is preferably in the range of about 0.5 mg/cm² to about 4.0 mg/cm². More efficient electro-oxidation is realized at higher loading levels.

The anode 110, the membrane 130, and the cathode 120 may be assembled into the membrane electrode assembly 140. Typically, the components are bonded together by hot pressing. Once bonded together, the anode 110, cathode 120 and membrane 130 form a single composite layered structure. Preferably, the electrode and the membranes are first laid or stacked on a CP-grade 5 Mil (0.013 cm), 12-inch (30.5 cm) by 12-inch (30.5 cm) titanium foil to prevent acid from the membrane from leaching into the electrode.

The invention will now be further described with reference to the following non-limiting example.

### EXAMPLE

A catalyst ink suitable for use as a cathode was prepared as follows. All weights were for a 36 cm² electrode, can be scaled up to make a larger electrode.

0.032 grams of MP-1100 TEFLON micro-particles and 0.180 grams of supported Pt-black catalyst (Johnson Matthey, Fuel Cell Grade) were combined with 0.400 grams of de-ionized water. 0.720 grams of a 5% NAFION membrane ionomer solution was added to the the water and catalyst mix.

The catalyst mix was sonicated in a water bath for at least 5 minutes to form an ink. The ink was used within about 10 minutes after preparation. It was determined that standing for longer periods caused separation of the phases and also possible reaction of the catalyst with air.

A NAFION membrane was placed in a fixture and roughened on both sides with a suitable 300-400 grit abrasive. A visual inspection revealed that there was no noticeable impregnation of the abrasive particles into the membrane surface. The membrane was allowed to dry, and the catalyst ink was painted on the surface of the membrane, with both the ink and the membrane at room temperature.

After drying on the substrate, the loading of the catalyst particles onto the substrate was in the target range of about 0.5 mg/cm² to about 4.0 mg/cm².

An anode ink was prepared for a 36 cm² electrode by conventional techniques. 0.144 grams of Pt-Ru catalytic material was placed in a glass vial with 0.400 grams of di-ionized water. 0.720 grams of a 5% NAFION membrane ionomer solution was added, and the mixture was sonicated in a water bath for about 5 minutes to form an ink.

The electrodes and membrane were bonded with heat and pressure to form an MEA. The MEA was tested for performance at low flow rates. Standard test procedures for assissing the performance of direct methanol fuel cells was used.

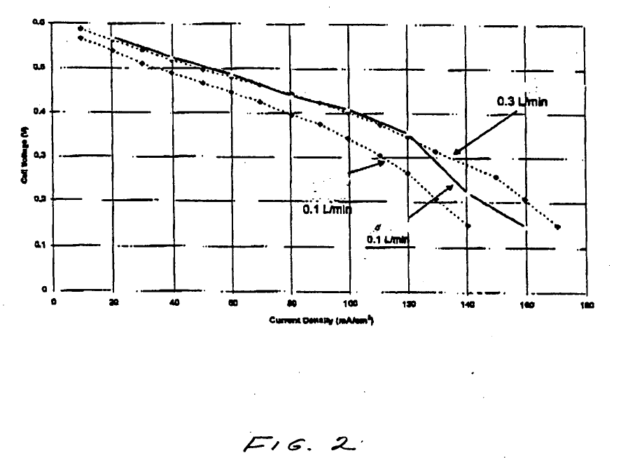

The plot in FIG. 2 compares the performance of a conventional MEA at an air flow rate of 0.3 L/min (curve I) with the MEA of the invention at an air flow rate of 0.1 L/min (curve II). The flow rate of 0.1 L/min is approximately 1.5 times the stoichiometric rate that is required for a 25 cm² cell operating at 100 mA/cm². The data in FIG. 2 demonstrate that at a current density of about 100 mA/cm², the MEA of the invention performed at the same cell voltage as the conventional design, using only a third of the air flow rate. Therefore, the MEA of the invention has improved performance at low air flow rates. This is also demonstrated by comparison with the conventional designs operating at 0.1 L/min (curve III). At low flow rates there is not enough air flowing to sustain very high current densities. Therefore, the performance at high current densities is expected to fall off precipitously. However, with the design of the present invention this situation appears to be slightly improved as well.

A number of embodiments of the invention have been described. Nevertheless, it will be understood that various modifications may be made without departing from the spirit and scope of the invention. Accordingly, other embodiments are within the scope of the following claims.

1. A catalyst ink for a fuel cell, comprising:
water;
particles of a fluorocarbon polymer with a particle size between 1 to 4 microns;
a perflourinated material which improves ion conduction; and
a catalytic material including platinum.

2. An ink as in claim 1, wherein the particles have a surface area of about 5 m²/g to about 10 m²/g.

3. An ink as in claim 1, wherein the catalytic material comprises substantially 60% platinum and 40% ruthenium.

4. An ink as in claim 1, wherein the fluorocarbon polymer is selected from the group consisting of polytetrafluoroethylene polymers and fluorinated ethylene-propylene polymers.

5. An ink as in claim 4, wherein the perflourinated material comprises a liquid copolymer of tetrafluoroethylene and perfluorvinyletherosulfonic acid.

6. An ink as in claim 4, wherein the ionomer comprises a liquid copolymer of tetrafluoroethylene and perfluorovinylethersulfonic acid.

7. A fuel cell membrane comprising:
a membrane, formed of a proton conducting material and having at least one side with particles from the group consisting of silicon nitride, boron nitride, silicon carbide, silica or boron carbide;
a catalyst ink, coupled to said one side forming a cathode, said catalyst ink including particles of a fluorocarbon polymer with a particle size between 1 to 4 microns, a perflourinated material which improves ion conduction, and a catalytic material including platinum; and
another material forming an anode, coupled to another side of said membrane.

8. A membrane as in claim 7, wherein said membrane is formed of Nafion perfluorinated proton exchange membrane material.

9. An ink as in claim 7, wherein the fluorocarbon polymer is selected from the group consisting of polytetrafluoroethylene polymers and fluorinated ethylene-propylene polymers.

10. An ink as in claim 7, wherein the ionomer comprises a liquid copolymer of tetrafluoroethylene and perfluorvinyletherosulfonic acid.

11. A fuel cell comprising:
a membrane, formed of a proton conducting material and having at least one side with particles from the group consisting of silicon nitride, boron nitride, silicon carbide, silica or boron carbide;
a cathode, including a catalyst ink, coupled to said one side, said catalyst ink including particles of a fluorocarbon polymer with a particle size between 1 to 4 microns, a perflourinated material which improves ion conduction, and a catalytic material including platinum;
an anode, coupled to another side of said membrane; and
electrodes, coupled respectively to said anode and cathode.

12. A fuel cell as in claim 11, wherein said membrane is formed of Nafion perfluorinated proton exchange membrane material.

13. An ink as in claim 11, wherein the fluorocarbon polymer is selected from the group consisting of polytetrafluoroethylene polymers and fluorinated ethylene-propylene polymers.

14. An ink as in claim 11, wherein the ionomer comprises a liquid copolymer of tetrafluoroethylene and perfluorvinyletherosulfonic acid.
